(19) United States
(12) Patent Application Publication
(10) Pub. No.: US 2002/0137631 A1
(43) Pub. Date: Sep. 26, 2002

(54) Anti-microbial composition

(76) Inventors: Stephen Brian Falder, Knutsford (GB); David Rawden, Stockport (GB)

Correspondence Address: Neil C. Jones, Nelson Mullins Riley & Scarborough, Keenan Building, Third Floor, 1330 Lady Street, Columbia, SC, 29201, US

(21) Appl. No.: 09/756,457

(22) Filed: Jan. 8, 2001

(30) Foreign Application Priority Data
Jan. 4, 2001 (GB) GB0100155.1

(51) Int. Cl. A01N 59/00; A01N 25/02; A01N 25/00

(52) U.S. Cl. 504/150; 504/362; 514/938

(57) ABSTRACT

An anti-microbial composition comprising (i) an anti-microbial agent, (ii) a polar solvent and (iii) a surface orienting species, which orients anti-microbial agent at a surface of the composition, whereby substantially to prevent the formation of microbial colonies on or at the said surface.

This invention relates to anti-microbial compositions and to formulations including the anti-microbial compositions.

Microorganisms are known to present health hazards due to infection or contamination. When microorganisms are present on the surface of a substrate they can replicate rapidly to form colonies. The microbial colonies form a coating on the substrate surface, which is known as a biofilm. Biofilms are more hazardous to health than individual microorganisms. Some microorganisms also produce polysaccharide coatings, which makes them more difficult to destroy.

Microorganisms attach themselves to substrates forming a biofilm comprising a “calyx” of polysaccharides and/or similar natural polymers as the affixing mechanism. Without this affixing point, the reproduction of the microorganism cannot proceed, or is at least seriously impaired.

Biofilm forms when bacteria adhere to surfaces in aqueous environments and begin to excrete a slimy, glue-like substance that can anchor them to all kinds of materials such as metals, plastics, soil particles, medical implant materials and tissue. A biofilm can be formed by a single bacterial species but more often biofilms consist of several species of bacteria, as well as fungi, algae, protozoa, debris and corrosion products. Essentially, biofilm may form on any surface exposed to bacteria and some amount of water. Once anchored to a surface, biofilm microorganisms carry out a variety of detrimental or beneficial reactions (by human standards), depending on the surrounding environmental conditions.

Many anti-microbial agents are known. For example, bacteriocidal, fungicidal, algicidal, yeasticidal and moldicidal agents are known. The anti-microbial agents can destroy microorganisms that are present in a wide range of environments such as medical, industrial, commercial, domestic and marine environments. Many of the known anti-microbial agents have previously been included in compositions for use in various applications and environments.

The known anti-microbial agents and the compositions that contain these anti-microbial agents destroy microorganisms by a number of different mechanisms.

For example, many anti-microbial agents are poisonous to microorganisms and, therefore, destroy microorganisms with which they are contacted. Examples of this type of anti-microbial agent include hypochlorites (bleaches), phenol and compounds thereof, arsenene and salts of arsenic. However, such agents typically are highly toxic to humans and animals as well as to microorganisms. Consequently the anti-microbial agents are dangerous to handle, and specialist handling, treatment and equipment are therefore required in order to handle these anti-microbial agents safely. The manufacture and disposal of compositions comprising this type of anti-microbial agent can, therefore, be problematic. There can also be problems associated with the use of compositions containing this type of anti-microbial agent, particularly in consumer materials where it is difficult to ensure that they are used for designated purposes.

Herein, unless the context indicates otherwise, “toxicity” is intended to refer to toxicity to complex organisms such as mammals. References to “toxic” are to be construed accordingly.

Once the anti-microbial agents enter the environment then they can affect the health of life forms that they were not intended to affect. Furthermore, the anti-microbial agents are often highly stable and can cause environmental problems for long periods of time.

Other known anti-microbial agents that are commonly used include organic and inorganic salts of heavy metals such as silver, copper or tin. These salts produce toxic rinsates, which can cause problems to the environment. For example, the rinsates of such salts are poisonous to aquatic life. Again, once the toxic compounds enter the environment they are not easily broken down and can cause persistent problems.

Other anti-microbial agents currently in use include antibiotic type compounds. Antibiotics disrupt the biochemistry within microorganisms, for example by selectively diluting solutions to destroy or inhibit the growth of harmful microorganisms. Although antibiotics are effective, it is currently believed that they may selectively permit the development of resistant strains of the species that they are used against. These resistant strains are then able to reproduce unimpeded by the use of known antibiotics. Thus, there is a growing concern that wide and uncontrolled use of antibiotic materials in the wider environment, as opposed to their controlled use in medical contexts, could produce significant long-term risks.

Another method of microbial control is the use of disinfectant materials, such as household bleach. These materials are effective in a wet environment for sterilization and cleansing. However, the materials do not provide long-term passive anti-microbial control and sanitisation. By “passive control” we mean that the substrate counters microbial infection on its own by some property within it, so that it does not require a cleaning regime to be effective at controlling microorganisms.

According to an aspect of the invention there is provided an anti-microbial composition comprising (i) an anti-microbial agent, (ii) a polar solvent and (iii) a surface orienting species, which concentrates the anti-microbial agent at a surface of the composition, whereby substantially to prevent the formation of microbial colonies on or at the said surface.

An advantage of the anti-microbial composition of the invention is that it increases the efficacy of the anti-microbial action of the anti-microbial agents compared to when they are used alone.

It seems that the anti-microbial composition of the present invention increases the efficacy of the anti-microbial agents because it disrupts the ability of a microbial colony to form a biofilm. Large numerous colonies are also substantially prevented from forming. Thus, the ability of the colony to grow is substantially reduced or even prevented.

The anti-microbial agents are associated with the surface orienting species and are oriented by the surface orienting species so that they are positioned close to the microbes on the surface or substrate. The surface orienting species, therefore, holds and orientates the anti-microbial agents at the surface so that a biofilm cannot form. The anti-microbial agents prevent the formation of the calyx, which greatly reduces the attachment and reproduction process. Thus, the orientation of the anti-microbial agents at the surface greatly enhances their efficacy. The prevention of the formation of a biofilm and the greatly reduced and attenuated colonies of microorganisms provides a substantially reduced risk due to infection or contamination. This has the beneficial effect of sanitizing products that incorporate the anti-microbial composition.

Another advantage of the anti-microbial composition is that it need not comprise combinations of materials that are highly toxic to mammals. The anti-microbial agents used in the anti-microbial compositions are typically well known and widely understood and tested anti-microbial agents. The efficacy of the known anti-microbial agents is amplified in the compositions of the invention. Therefore, anti-microbial agents that have a low toxicity can be used in the anti-microbial compositions. In contrast, new anti-microbial agents for broader or more complete sanitization use “stronger”, more toxic and/or little tested materials. The anti-microbial composition also does not comprise materials that produce highly persistent residues or rinsates or products that contain heavy metals and their salts. Thus, there is a greatly reduced risk of long term hazards associated with the anti-microbial compositions.

The composition of the present invention does not interfere with the biochemical reproductive pathways of the microorganisms it controls. The risk of resistance build up and the development of resistant strains is, therefore, highly unlikely.

By the term “anti-microbial agent” we mean any chemical substance that can destroy microorganisms.

Preferably, the composition comprises at least one anti-microbial agent selected from bacteriocidal, fungicidal, algicidal, yeasticidal and moldicidal agents.

Preferably, the anti-microbial composition comprises two or more anti-microbial agents.

The anti-microbial agents present in the compositions of the invention are typically well known and have been subject to research by the regulatory authorities. The anti-microbial agents generally have some effect when they are used alone. However, the efficacy of the anti-microbial agents is amplified when they are used in combination with a surface orienting species.

The anti-microbial agent is preferably of a polar nature. This assists in the orientation of the anti-microbial agent by the surface orienting species.

The anti-microbial agent is preferably an amphoteric compound, an iodophore, a phenolic compound, a quaternary ammonium compound, a hypochlorite or a nitrogen based heterocyclic compound.

More preferably, the anti-microbial compositions of the present invention comprise one or more quaternary ammonium compounds, phenolic compounds and nitrogen based heterocyclic compounds as the anti-microbial agent.

Amphoteric compounds suitable for use in the present invention include long chain N-alkyl derivatives of amino acids. Long chain N-alkyl derivatives of glycine, alanine and beta-amino butyric acid are preferred. Particularly preferred compounds include dodecyl beta-alanine, dodecyl beta-aminobutyric acid, dodecylamino-di(aminoethylamino)glycine and N-(3-dodecylamino) propylglycine.

By the term “iodophores” we mean complexes of iodine or triodine with a carrier, such as a neutral polymer. The carrier typically increases the solubility of iodine in water, provides a sustained release of the iodine and reduces the equilibrium concentrations of free iodine.

Suitable polymeric carriers from which iodophores can be prepared include polyvinylpyrrolidone, polyether glycols such as polyethylene glycols, polyvinyl alcohols, polyacrylates, polyamides, polyalkylenes and polysaccharides.

Quaternary ammonium compounds that are suitable for use in the present invention include compounds of formula R¹R²R³R⁴N⁺X⁻, in which one or two of the R groups are alkyl, optionally substituted by aryl or optionally interrupted by aryl or a heteroatom, such as oxygen, and the other R groups are the same or different and are C₁ to C₄ alkyl groups.

Preferred quaternary ammonium compounds include benzalkonium halides, aryl ring substituted benzalkonium halides, such as ethyl-substituted benzalkonium halides, and twin chain quaternary ammonium compounds, such as dialkyldimethyl ammonium compounds wherein the two non-methyl alkyl groups are selected from medium and long chain alkyl groups, such as C₈ to C₁₂ alkyl, preferably octyl and dodecyl.

Suitable quaternary ammonium compounds in which an R group (i.e. R¹, R², R³, R⁴) contains a heteroatom include domiphen bromide, benzalkonium chloride and methylbenzalkonium chloride.

Other quaternary ammonium compounds suitable for use in the anti-microbial composition include alkylpyridinium compounds, such as cetylpyridinium chloride, and bridged cyclic amino compounds such as the hexaminium compounds.

Particularly preferred quaternary ammonium compounds include benzenethanaminiumn N-dodecyl-N,N-dimethylchloride, benzenethanaminiumn N-dodecyl-N,N-dimethyl-N-tetradecylchloride and benzyl-C₁₂-C₁₆-alkyldimethyl-ammoniumchloride.

Suitable phenolic compounds include methyl, ethyl, butyl, halo and aryl substituted phenol. Preferred phenolic compounds include 2-phenylphenol, 2-benzyl-4-chlorophenol, 2-cyclopentanol-4-chlorophenol, 4-t-amylphenol, 4-t-butylphenol, 4-chloro-2-pentylphenol, 6-chloro-2-pentylphenol, p-chloro-meta-xylenol, 2,4,4-trichloro-2-hydroxydiphenol, thymol, 2-i-propyl-3-methylphenol, chlorothymol, 3-methyl-4-chlorophenol, 2,6-dichloro-4-n-alkyl phenols, 2,4-dichloro-meta-xylenol, 2,4,6-trichlorophenol and 2-benzyl-4-chlorophenol.

Suitable hypochlorites include alkali metal and alkaline earth metal hypochlorites, such as the hypochlorites of lithium, sodium, potassium and calcium. Other suitable hypochlorites include chlorinated trisodium phosphate and their various hydrates. Other suitable chlorine containing or chlorine releasing agents include chlorine dioxide and its precursors, as well as N,N-dichloro-4-carboxybenzenesulponamide (halazone), 1,3-dichloro-5,5-dimethylhydantoin (halane) and various chloroisocyanuric acid derivatives.

Suitable nitrogen based heterocyclic compounds include pyridine derivatives, such as 4-pyridine carboxylic acid hydrazide, sodium 2-pyridinethiol-1-oxide and bis-(2-pyridylthio)zinc-1,1-dioxide, triazoles and imidazoles.

A particularly preferred anti-microbial composition comprises benzenethanaminiumn N-dodecyl-N,N-dimethylchloride, benzenethanaminiumn N-dodecyl-N,N-dimethyl-N-tetradecylchloride, benzyl-C₁₂-C₁₆-alkyldimethyl-ammoniumchloride, 2-phenylphenol, 2-octyl-2H-isothiazol-3-one, 5-chloro-2-methyl-2H-isothiazol-3-one and 2-methyl-2H-isothiazol-3-one.

The particular anti-microbial agents selected for use in the compositions will vary depending upon the environment in which the compositions is intended to be used.

The surface orienting species is preferably a surfactant or oil, more preferably a short chain surfactant or oil. By the term “short chain” we mean C₁₂ to C₂₀. Suitable surface orienting species include polysiloxane, polyethylene glycol, sodium lauryl sulphate and soya lecathin.

The surface orienting species align and orient themselves at the surface or interface of the products that they are incorporated in. As a result, the surface orienting species also orients the anti-microbial agents in the composition.

The surface orienting species typically possess both hydrophobic and hydrophilic groups. This assists in the orientation process.

Preferably, the composition comprises from 1 to 4% by volume of the surface orienting species; however other proportions are possible and lie within the scope of the invention.

Suitable polar solvents for use in the composition include water, alcohols, esters, hydroxy and glycol esters, polyols and ketones.

Preferred alcohols for use in the composition include straight or branched chain C₁ to C₅ alcohols, particularly methanol, ethanol, propanol, iso-propanol, n-butanol, sec-butanol, tert-butanol, iso-butanol, 2-methyl-1-butanol, 1-pentanol and amyl alcohol (mixture of isomers).

Preferred esters for use in the composition include methyl acetate, ethyl acetate, n-propyl acetate, iso-propyl acetate, n-butyl acetate, iso-butyl acetate, sec-butyl acetate, amyl acetate (mixture of isomers), methylamyl acetate, 2-ethylhexyl acetate and iso-butyl isobutyrate.

Preferred hydroxy and glycol esters for use in the composition include methyl glycol acetate, ethyl glycol acetate, butyl glycol acetate, ethyl diglycol acetate, butyl diglycol acetate, ethyl lactate, n-butyl lactate, 3-methoxy-n-butyl acetate, ethylene glycol diacetate, polysolvan O, 2-methylpropanoic acid-2,2,4-trimethyl-3-hydroxypentyl ester, methyl glycol, ethyl glycol, isopropyl glycol, 3-methoxybutanol, butyl glycol, iso-butyl glycol, methyl diglycol, ethyl diglycol, butyl diglycol, isobutyl diglycol, diethylene glycol, dipropylene glycol, ethylene glycol monohexyl ether and diethylene glycol monohexyl ether.

Preferred polyols for use in the composition include ethylene glycol, propylene glycol, 1,3-butylene glycol, 1,4-butylene glycol, hexylene glycol, diethylene glycol, triethylene glycol and dipropylene glycol.

Preferred ketones for use in the composition include isobutyl heptyl ketone, cyclohexanone, methyl cyclohexanone, methyl isobutenyl ketone, pent-oxone, acetyl acetone, diacetone alcohol, isophorone, methyl butyl ketone, ethyl propyl ketone, methyl isobutyl ketone, methyl amyl ketone, methyl isoamyl ketone, ethyl butyl ketone, ethyl amyl ketone, methyl hexyl ketone, diisopropyl ketone, diisobutyl ketone, acetone, methyl ethyl ketone, methyl propyl ketone and diethyl ketone.

Particularly preferred polar solvents for use in the composition include isopropanol, diethylene glycol and dipropylene glycol.

The polar solvent further enhances the orientation of the anti-microbial agents in the composition. It seems that the polar solvent enhances the orientation because it ensures that only one end of the surface active agent is solvated.

Preferably, the composition comprises from 1 to 70% by volume of the polar solvent, but since the primary purpose of the solvent is dilution virtually any proportion of polar solvent is believed to be possible within the scope of the invention.

An especially preferred anti-microbial composition comprises 32% by volume of a mixture of benzenethanaminiumn N-dodecyl-N,N-dimethylchloride and benzenethanaminiumn N-dodecyl-N,N-dimethyl-N-tetradecylchloride (2.33:1), 6.0% by volume benzyl-C₁₂-C₁₆-alkyldimethyl-ammoniumchloride and 2-phenylphenol (2:1), 6.0% by volume of 2-octyl-2H-isothiazol-3-one, 16.0% by volume of a mixture of 5-chloro-2-methyl-2H-isothiazol-3-one and 2-methyl-2H-isothiazol-3-one (3:1), 1.0% by volume a blend of polysiloxanes and balance by volume isopropanol.

Another especially preferred anti-microbial composition comprises 5.0% by volume of a mixture of benzenethanaminiumn N-dodecyl-N,N-dimethylchloride and benzenethanaminiumn N-dodecyl-N,N-dimethyl-N-tetradecylchloride (2.33:1), 5.0% by volume benzyl-C₁₂-C₁₆-alkyldimethyl-ammoniumchloride and 2-phenylphenol (2:1), 12.0% by volume of 2-octyl-2H-isothiazol-3-one, 32.0% by volume of a mixture of 5-chloro-2-methyl-2H-isothiazol-3-one and 2-methyl-2H-isothiazol-3-one (3:1), 1.0% by volume a blend of polysiloxanes and balance by volume diethyleneglycol.

A further especially preferred anti-microbial composition comprises 6.0% by volume of a mixture of benzenethanaminiumn N-dodecyl-N,N-dimethylchloride and benzenethanaminiumn N-dodecyl-N,N-dimethyl-N-tetradecylchloride (2.33:1), 6.0% by volume benzyl-C₁₂-C₁₆-alkyldimethyl-ammoniumchloride and 2-phenylphenol (2:1), 16.0% by volume of 2-octyl-2H-isothiazol-3-one, 32.0% by volume of a mixture of 5-chloro-2-methyl-2H-isothiazol-3-one and 2-methyl-2H-isothiazol-3-one (3:1), 1.0% by volume a blend of poylsiloxanes and balance by volume isopropanol.

Yet another especially preferred anti-microbial composition comprises 6.0% by volume of a mixture of benzenethanaminiumn N-dodecyl-N,N-dimethylchloride and benzenethanaminiumn N-dodecyl-N,N-dimethyl-N-tetradecylchloride (2.33:1), 6.0% by volume benzyl-C₁₂-C₁₆-alkyldimethyl-ammoniumchloride and 2-phenylphenol (2:1), 16.0% by volume of 2-octyl-2H-isothiazol-3-one, 32.0% by volume of a mixture of 5-chloro-2-methyl-2H-isothiazol-3-one and 2-methyl-2H-isothiazol-3-one (3:1), 1.0% by volume a blend of polysiloxanes and balance by volume dipropyleneglycol.

According to a further aspect of the invention, there is provided a formulation comprising an anti-microbial composition and at least one other functional material.

Suitable functional materials include plastics, fibres, coatings, films, laminates, adhesives, sealants, clays, china, ceramics, concrete, sand, paints, varnishes, lacquers, cleaning agents or settable or curable compositions such as fillers, grouts, mastics and putties.

The plastics may be in the form of films, sheets, stabs and molded plastic parts. Suitable plastics materials may be prepared from polyesters such as polyethylene terephthalate, polybutylene terephthalate, polyamides such as Nylon, polyimides, polypropylene, polyethylene, polybutylenes, polymethylpentene, polysiloxane, polyvinyl alcohol, polyvinylacetate, ethylene-vinylacetate, polyvinyl chloride, polyvinylidene chloride, epoxy, phenolic and polycarbonate cellulosics, cellulose acetate, polystyrene, polyurethane, acrylics, polymethyl methacrylate, acrylonitrile, butadiene-styrene copolymer, acrylonitrilestyrene-acrylic copolymers, acetals, polyketones, polyphenylene ether, polyphenylene sulfide, polyphenylene oxide, polysulfones, liquid crystal polymers and fluoropolymers, amino resins, thermo plastics, elastomers, rubbers, such as styrene butadiene rubber and acrylonitrile butadiene rubber, polyacetal (polyoxymethylene), and blends and copolymers thereof.

Formulations comprising the anti-microbial composition and a plastics material as the functional material may, for example, be used to form products such as automobile parts, shower curtains, mats, protective covers, tape, packaging, gaskets, waste containers, general purpose containers, brush handles, sponges, mops, vacuum cleaner bags, insulators, plastic film, indoor and outdoor furniture, tubing, insulation for wire and cable, plumbing supplies and fixtures, siding for housing, liners, non-woven fabrics, kitchen and bathroom hardware, appliances and equipment, countertops, sinks, flooring, floor covering, tiles, dishes, conveyer belts, footwear including boots, sports equipment and tools.

Suitable fibres may be prepared from acetate, polyester such as PET and PTT, polyolefins, polyethylene, polypropylene, polyamides such as Nylon, acrylics, viscose, polyurethane, and Rayon, polyvinyl alcohol, polyvinyl chloride, polyvinylidene chloride, polysaccharide, and copolymers and blends thereof.

Formulations comprising the anti-microbial composition and a fibre as the functional material may, for example, be used in applications such as mattress cover pads and filling, pillow covers, sheets, blankets, fiberfill for quilts and pillows, curtains, draperies, carpet and carpet underlay, rugs, upholstery, table cloths, napkins, wiping cloths, mops, towels, bags, wall covering fabrics, cushion pads, sleeping bags and brush bristles. The fibres are also suitable for use in automotive and truck upholstery, carpeting, rear decks, trunk liners, convertible tops and interior liners. Furthermore, the fibres are suitable for use in umbrellas, outerwear, uniforms, coats, aprons, sportswear, sleepwear, stockings, socks, hosiery caps, and undergarment and inner liners for jackets, shoes, gloves and helmets, trim for outerwear and undergarments as well as brush bristles, artificial leather, filters, book covers, mops, cloth for sails, ropes, tents, and other outdoor equipment, tarps and awnings.

Coatings suitable for use in the formulations include water-borne, solvent-borne, 100% solids and/or radiation cure coatings. The coatings may be liquid or powder coatings.

Suitable coatings, films and laminates include alkyds, amino resins, such as melamine formaldehyde and urea formaldehyde, polyesters, such as unsaturated polyester, PET, PBT, polyamides such as Nylon, polyimides, polypropylene, polyvinylacetate, ethylene-vinylacetate, polyvinyl chloride, polyvinylidene chloride, epoxy, phenolic and polycarbonate cellulosics, cellulose acetate, polystyrene, polyurethane, acrylics, polymethyl methacrylate, acrylonitrile-butadiene-styrene copolymer, acrylonitrile-styreneacrylic copolymers, acetals, polyketones, polyphenylene ether, polyphenylene sulfide, polyphenylene oxide, polysulfones, liquid crystal polymers and fluoropolymers, thermoplastic elastomers, rubbers such as styrene butadiene rubber, acrylonitrile butadiene rubber, polyacetal (polyoxymethylene), and blends and copolymers thereof.

Formulations comprising the anti-microbial composition and coatings as the functional material may, for example, be used on walls, wall boards, floors, concrete, sidings, roofing shingle, industrial equipment, natural and synthetic fibres and fabrics, furniture, automotive and vehicular parts, packaging, paper products (wall coverings, towels, book covers) barrier fabrics, and glazing for cement tile and for vitreous china used in plumbing fixtures such as toilets, sinks, and countertops other than kitchen countertops.

Adhesives and sealants suitable for use in the formulations include hot-melt, aqueous, solvent borne, 100% solids and radiation cure adhesives and sealants.

Suitable adhesives and sealants include alkyds, amino resins, such as melamine formaldehyde and urea formaldehyde, polyesters, such as unsaturated polyester, PET, PBT, polyamides such as Nylon, polyimide polypropylene, polyethylene, polybutylene, polymethylpentene, polysiloxane, polyvinyl alcohol, polyvinylacetate, ethylene-vinylacetate, polyvinyl chlorides, such as plastisol, polyvinylidene chloride, epoxy, phenol and polycarbonate, cellulosics, cellulose acetate, polystyrene, polyurethane, acrylics, polymethyl methacrylate, acrylonitrile-butadienestyrene copolymer, acrylonitrile-styrene-acrylic copolymers, acetals, polyketones, polyphenylene ether, polyphenylene sulfide, polyphenylene oxide, polysulfones, liquid crystal polymers and fluoropolymers, thermoplastic elastomers, rubbers (including styrene butadiene rubber, acrylonitrile butadiene rubber, CR), polyacetal (polyoxymethylene), and blends and copolymers thereof.

Formulations comprising the anti-microbial composition and an adhesive or sealant as the functional material may, for example, be used in the manufacture of wood and plastic composites, adhesives for ceramic tiles, wood, paper, cardboard, rubber and plastic, glazing for windows, grout, sealants for pipes, adhesives, sealants and insulating materials for appliances, bathrooms, showers, kitchens, and construction.

Formulations comprising the anti-microbial composition and clay, china, ceramics, concrete, sand or grout as the functional material may, for example, be used in toilets, sinks, tile, flooring, stucco, plaster, cat litter, drainage and sewerage pipe.

The anti-microbial composition can be combined into a very wide variety of functional compounds for the manufacturing, contracting and construction industries. The nature of the anti-microbial composition may be varied according to the particular functional compounds and the number and nature of microorganisms present in the particular functional compound or environment in which it is used.

The formulation preferably comprises from 0.1 wt % to 5.0 wt %, more preferably from 0.5 wt % to 2.0 wt %, of the anti-microbial composition.

The anti-microbial composition is highly effective against a broad range of microorganisms even when it is combined with another functional material to provide the formulation of the invention. The formulation can, optionally, be applied to a surface. The formulation provides long-term anti-microbial action, in both dry and damp conditions at the surfaces treated or in which the material is combined. This will lead to a sanitisation of the surfaces so that the surfaces and products will prevent the rapid replication of microbial species and, thus, substantially reduce the risks of contamination and infection.

The anti-microbial composition is mobile through most functional materials in which it is incorporated in the formulations of the invention. This is due to the presence of surfactant materials and oils and molecules of short chain length. In order to maintain this mobility, the surfactant materials and oils preferably have a carbon chain length of no greater than 20.

The anti-microbial composition tends to migrate across a concentration gradient and moves to the surface of products into which it has been incorporated. This is similar to the behaviour of plasticiser in polymers.

Both the anti-microbial composition and the formulation typically begin to dissociate into their component parts when they have been in continuous contact with water for longer than six to eight hours. The anti-microbial action, of the anti-microbial composition and the formulation, is substantially reduced once the composition and formulation have dissociated into their component parts. The components can then act as a carbon source or nutrient for many species of microorganisms. Thus, the anti-microbial composition and the formulation can degrade when submersed in water, to provide a rinsate/leachate of low toxicity and which has a short residence time in the environment.

The formulation can be designed so that it is stable and effective in most manufacturing environments. The formulation is typically stable up to temperatures of 200° C.

The property of mobility of the product permits materials that are highly frequently washed or rinsed to be “recharged” with the anti-microbial composition during a routine act of cleaning or maintenance.

Typically, the anti-microbial composition is incorporated into a simple conventional detergent solution or added to a “final rinse” during cleaning. The anti-microbial composition will be drawn, due to the presence of its hydrophobic elements, into the surface of the product to be “recharged”. The sanitization properties of the formulation are, therefore, restored without the need for re-manufacture or difficult treatment processes.

Any wash off or rinsates containing the anti-microbial composition or formulation diluted by such a re-charging solution and water would quickly dissociate into the biodegradable components as previously discussed.

According to a further aspect of the invention, there is provided the use of an anti-microbial composition to prevent the formation of colonies of microorganisms on a surface at which it is provided.

According to yet a further aspect of the invention, there is provided the use of a formulation to prevent the formation of colonies of microorganisms on a surface at which it is provided.

The anti-microbial composition and formulation have an anti-bacterial effect against a wide range of gram-positive and gram-negative bacteria.

For example, they are effective against the following:

Bacillus species, such as Bacillus subtilis, Bacillus cereus

Brevibacterium species

Brucella species, such as Brucella abortus,

Lactobacillus species

Proteus vulgaris

Pseudomonas aeruginosa

Salmonella species

Staphylococcus species, such as Methicillin Resistive

Staphylococcus aureus (MRSA)

Streptococcus species

Flavobacterium species

Escherichia species

Aeromonas species

The anti-microbial composition and formulation also have activity against fungi and yeasts, such as:

Penicillium species

Aspergillus niger

Cladosporium species

Fusarium species

Paecilomyces species

Streptomyces species

Saccharomyces species, such as S.cerevisiae

Monilia albicans

The anti-microbial composition and formulation also have activity against certain species of algae such as:

Chlorella pyrenoidosa

Pleurococcus

Anabaena Species

According to another aspect of the invention, there is provided a method of manufacturing an anti-microbial composition, the method comprising the steps of (i) mixing the anti-microbial agents together, (ii) adding the surface orienting species to the mixture of anti-microbial agents, (iii) adding the solvent to the mixture of the anti-microbial agents and surface orienting species and (iv) agitating the resulting mixture until a clear solution is formed.

According to yet a further aspect of the invention, there is provided a method of manufacturing a formulation, the method comprising the step of adding the anti-microbial composition to the functional compound.

The present invention is now illustrated but not limited with reference to the following examples.

### EXAMPLE 1

Preparation of Anti-Microbial Composition (“D4L”)

A composition according to the present invention comprising components (a) to (f) in the amounts indicated was prepared:

(a) 32.0% by volume of a mixture of two benzalkonium chlorides (in a ratio of 2.33:1) i.e. benzenethanaminiumn N-dodecyl-N,N-dimethylchloride and benzenethanaminiumn N-dodecyl-N,N-dimethyl-N-tetradecyl-chloride (Trade Name: BAC-50m);

(b) 6.0% by volume of a mixture of benzyl-C₁₂-C₁₆-alkyldimethyl-ammoniumchloride (CAS no. 68424-85-1) and 2-phenyl phenol in the ratio 2:1;

(c) 6.0% by volume of 2-octyl-2H-isothiazol-3-one (Trade Name: A-DW);

(d) 16.0% by volume of a mixture of 5-chloro-2-methyl-2H-isothiazol-3-one and 2-methyl-2H isothiazol-3-one in the ratio 3:1 (Trade Name: A-14);

(e) 1.0% by volume of polysiloxane (Trade Name: PD-D); and

(f) 39% by volume of an isopropanol blend (isopropanol, n-propanol and water to azeotropic limit about 1.0%).

Anti-microbial agents a, b, c and d were mixed together sequentially at room temperature following the sequence described above. The resulting mixture was then agitated thoroughly and the polysiloxane (e) was added to the mixture. The resulting mixture was agitated and isopropanol (f) was added. The mixture was then agitated until a clear solution was obtained. The clear solution is referred to herein as “D4L”.

### EXAMPLE 2

Preparation of Detergent Formulation Comprising the Anti-Microbial Agent Composition of Example 1 (i.e. D4L)

An amphoteric non-ionic detergent, such as washing-up liquid, having a pH of from 6 to 8, was diluted in water in a ratio of 1 part detergent to 25 parts of water by volume. To this solution was added between 0.5 and 2.0% by volume of the anti-microbial agent composition prepared according to Example 1 (i.e. D4L).

### EXAMPLE 3

Effectiveness of Anti-Microbial Agent Formulation Against Escherichia coli, Staphylococcus aureus and Pseudomonas aeruginosa.

### Method

Two samples were tested. These were a detergent formulation prepared according to Example 2 comprising 2% of the anti-microbial agent composition of Example 1 and a neutral detergent. The neutral detergent was used as a standard reference.

A bacterial culture (0.1 ml) in a nutrient medium was applied to a previously sterilised petri dish over an area 7×5 cm. The bacterial culture was then allowed to dry for 30 minutes.

The inoculated area was then wiped with a test wipe soaked either in water or the test solution to contact the test fluid with the bacteria. The test solution was applied using either an absorbent cloth or an innoculum loop. The innoculated area was also left untreated to provide an “uncleaned control”, in which the infected area was not washed or even wiped with water. The bacteria remaining on the surface of the petri dish were numerated after periods of 15 and 30 seconds.

The bacteria remaining on the surface of the petri dish were numerated by wetting a sterile swab in a sterile peptone solution (0.1%) and thoroughly rubbing the swab over the area to be sampled, turning the swab as it was rubbed over the appropriate area. The swab was then returned to a sterile tube; Ringers solution (5 ml, ¼ strength) was added; and the swab left for at least 10 minutes.

The swab tubes were plated out making serial decimal dilutions, using the Miles and Misra Total Viable Count, Technique and incubated inverted at 37° C. overnight. The number of colony forming units (CFU) (taken to be viable bacterial individuals) was then counted.

### Calculation

The log reduction in bacterial numbers was calculated compared to the water control and the uncleaned control.

The total number of CFUs per ml of neat sample was calculated for each test sample and the controls.

The log of the number of CFUs for the water control, or the uncleaned control, was calculated to give value A. This was repeated for the test anti-microbial composition to give value B.

A-B=Log Reduction (A=log CFUs water or uncleaned control, B=log CFU5 test sample)

A log reduction of greater than 4 is considered to be effective.

TABLE 1
Results

| | | Log reduction | Log reduction |
|---|---|---|---|
| Composition | Organism | after 15 secs | after 30 secs |
| Anti-microbial | Escherichia coli^{a} | 1.0 | >4.0 |
| composition | | | |
| Anti-microbial | Staphylococcus | >4.9 | >4.9 |
| composition | aureus^{b} | | |
| Anti-microbial | Pseudomonas | 1.8 | 3.3 |
| composition | aeruginosa^{c} | | |

^{a}Total viable count 6.8 × 10⁸
^{b}Total viable count 5.8 × 10⁸
^{c}Total viable count 1.5 × 10⁹

### Conclusions

A 2% solution of the anti-microbial composition gave a log reduction of 1.0 after 15 seconds and >4.0 after 30 seconds when tested against Escherichia coli.

A 2% solution of anti-microbial composition gave a log reduction of >4.9 after 15 seconds when tested against Staphylococcus aureus.

A 2% solution of anti-microbial composition 4 gave a log reduction of 1.8 after 15 seconds and 3.3 after 30 seconds when tested against Pseudomonas aeruginosa.

### EXAMPLE 4

Resistance of Painted Film Formulations Containing an Anti-Microbial Composition to Dry Film Fungal and Algal Colonisation

### Method

The following formulations were tested:

| | % Anti-microbial |
|---|---|
| Composition Number | Composition |
| Control | 0.00% |
| 1 | 0.50% |
| 2 | 0.75% |
| 3 | 1.00% |
| 4 | 1.50% |
| 5 | 2.00% |

Method—Dry Film Fungal Resistance Test (Based on British Standard BS3900 Part G6)

Each sample was painted onto 6×9 cm gypsum panels. Two coats of each sample were painted onto the gypsum panels, allowing 24 hours drying time between each coat. When the panels were dry, they were spray inoculated with a mixed spore suspension prepared from fungi (including yeasts) isolated from or known to grow on painted surfaces. The test panels were suspended in a high humidity cabinet at 24° C. for four weeks and the resultant fungal growth assessed visually and microscopically.

Fungal growth rating was according to BS3900 Part G6.

The micro-organisms used were:

Aspergillus versicolor

Aureobasidium pullulans

Cladosporium cladosporioides

Penicillium purpurogenum

Phoma violaceae

Rhodotorula rubra

Sporobolomyces roseus

Stachybotrys chartarum

Ulocladium atrum

Method—Dry Film Algal Resistance Test—Vermiculite Bed Method

Each sample was painted onto 10×10 cm calcium silicate panels. Two coats of each sample were painted onto the panels, allowing 24 hours drying time between each coat. When the panels were dry, they were weathered using a QUV Accelerated Weathering Tester for 125 hours using a water spray cycle. Each panel was then cut in half. The half panels were placed in the surface of vermiculite (200 g) moistened with water (800 cm³) in a transparent plastic box with a close fitting lid. The panels were each spray inoculated with a mixed algal suspension three times at intervals of two weeks and sprayed with water each week. The panels were incubated for 13 weeks at 20° C. and illuminated with 30 W daylight type fluorescent tubes (giving approximately 1000 lux) for 16 hours per day. The resultant algal growth was assessed visually and microscopically.

The micro-organisms used were:

Chlorella emersonii

Gloeocapsa alpicola

Nostoc commune

Pleurococcus sp.

Stichococcus bacillaris

Stigeoclonium tenue

Trentepohlia aurea

Trentepohlia odorata

### Results

TABLE 2
Dry Film Fungal Resistance Test

| | | Observed Rating* |
|---|---|---|
| Composition Number | % Anti-microbial agent | (4 weeks) |
| Control | 0.00% | 4 (40+) |
| 1 | 0.50% | 3 (30+) |
| 2 | 0.75% | 2 (10+) |
| 3 | 1.00% | 2 (5+) |
| 4 | 1.50% | 2 (5+) |
| 5 | 2.00% | 0 (0) |

*Average rating of replicate panels given.

TABLE 3
Dry Film Algal Resistance Test

| | | Film Algal | |
|---|---|---|---|
| Composition | % Anti-microbial | Growth- | Rating/Intensity |
| Number | agent | Replicate 1 | -Replicate 2 |
| Control | 0.00% | 4 (50+) | 4 (40+) |
| 1 | 0.50% | 3 (20+) | 3 (20+) |
| 2 | 0.75% | 2 (10+) | 3 (15+) |
| 3 | 1.00% | 2 (10+) | 2 (10+) |
| 4 | 1.50% | 2 (10+) | 2 (10+) |
| 5 | 2.00% | 2 (5+) | 2 (5+) |

### Growth Ratings

The first figure represents the fungal growth cover as follows:

0=No growth

1=Trace growth

2=1 to 10% Coverage of growth

3=11 to 30% Coverage of growth

4=31 to 70% Coverage of growth

5=71 to 100% Coverage of growth

The second figure in brackets represents the % cover and an assessment of the intensity rating, as follows:

0=Growth barely visible to the naked eye

+=Light growth

++=Moderate growth

+++=Dense growth

### SUMMARY

The control sample (containing no anti-microbial composition) was found to be susceptible to dry film fungal and algal colonisation.

An addition of 1.0% of the anti-microbial composition was found to control the fungal and algal population to a level that meets the pass criterion, of below 20%.

### EXAMPLE 5

Microbiological Testing Against MRSA of Becker International's Coil Coating Panels Treated with the Anti-Microbial Composition of Example 1

Coil coating panels, from Becker International, were treated with a range of concentrations of an anti-microbial composition according to Example 1. The panels were then tested to demonstrate whether they have antibacterial properties against Methicillin resistant Staphylococcus Aureus (MRSA).

The panels were coated as follows:

S1 Coil coating panel, 1.0% anti-microbial composition

S2 Coil coating panel, 1.5% anti-microbial composition

S3 Coil coating panel, 2.0% anti-microbial composition

S4 Coil coating panel, 2.5% anti-microbial composition

S5 Coil coating panel, 3.0% anti-microbial composition

S6 Coil coating panel, 0% anti-microbial composition (control)

### Method

The MRSA culture was diluted to approximately 1.5×10⁴ CFU/ml with sterile deionised water. 1 ml of this solution was placed on a coil coating panel and was continuously applied over an area of approximately 5 cm×5 cm using a hand held spreader for a contact period of 1 minute. The culture was immediately recovered from the panel using a swab and was transferred to a universal bottle containing neutralizer (1 ml) and maximum recovery diluent (9 ml). 10 fold serial dilutions were prepared and 0.1 ml aliquots of the dilutions were plated onto nutrient agar, in duplicate. The plates were incubated at 37° C. for 24 hours and 48 hours and read using conventional techniques.

The procedure was repeated with a culture contact time of 5 minutes. All six samples were subjected to the same test protocol.

TABLE 4
Results

| | Contact time 1 min | Contact time 5 min |
|---|---|---|
| Sample | (CFU/ml) | (CFU/ml) |
| S1 | 82 | 55 |
| S2 | 73 | 50 |
| S3 | 60 | 38 |
| S4 | 55 | 35 |
| S5 | 49 | 30 |
| S6 | 1.1 × 10³ | 2.5 × 10² |

### Conclusion

All of the test samples (S1 to S5) produced very significant decreases in the bacterial count (from 1.5×10³ CFU/ml) in 1 minute of contact time and further small decreases after 5 minutes. Total bacterial kill was not achieved in 5 minutes of contact.

The control sample (S6) produced a small decrease in the bacterial count (from 1.5×10³ CFU/ml) in 1 minute of contact time, which may be primarily due to the difficulty of recovering the culture from the panels using swabbing techniques. After 5 minutes of contact time the control samples bacterial count had significantly decreased primarily due to the drying out of the culture during the continuous spreading action on the panels.

The coil coatings treated with the anti-microbial composition are effective, at all of the tested concentrations, in very significantly reducing the level of MRSA bacteria when in contact in an aqueous medium for short periods.

These coatings would be very effective in assisting in the control of MRSA bacterial contamination in hospitals and similar environment.

### EXAMPLE 6

Microbiological Testing Against MRSA of HMG's Panels of Food Safe PVC 94 Laminate Treated with the Anti-Microbial Composition of Example 1

Panels, from H. Marcel Guest Ltd (HMG), coated with food safe PVC 94 laminate were treated with a formulation comprising a paint and 2% of the anti-microbial composition prepared according to Example 1 in order to demonstrate whether they have antibacterial properties against Methicillin resistant Staphylococcus Aureus (MRSA).

### Samples

S1 PVC 94 laminated panel, 2% anti-microbial composition, Clear.

S2 Control; Clear.

S3 PVC 94 laminated panel, 2% anti-microbial composition, White.

S4 Control; White.

### Method

The MRSA culture was diluted to approximately 1.5×10⁴ CFU/ml with sterile deionised water and 1 ml was placed on a panel and continuously applied over an area of approximately 5 cm×5 cm using a hand held spreader for a contact period of 1 minute. The culture was immediately recovered from the panel using a swab and was transferred to a universal bottle containing neutralizer (1 ml) and maximum recovery diluent (9 ml). 10 fold serial dilutions were prepared and 0.1 ml aliquots of the dilutions were plated onto nutrient agar, in duplicate. The plates were incubated at 37° C. for 24 hours and 48 hours and read using conventional techniques. The procedure was then repeated with a culture contact time of 5 minutes. All four samples were subjected to the same test protocol.

TABLE 5
Results

| | Contact Time 1 min | Contact Time 5 min |
|---|---|---|
| Sample | (CFU/ml) | (CFU/ml) |
| S1 | 52 | 30 |
| S2 | 2.1 × 10² | 1.6 × 10² |
| S3 | 97 | 31 |
| S4 | 4.1 × 10² | 1.9 × 10² |

### Discussion

The test samples (S1 and S3) produced very significant decreases in the bacterial count (from 1.5×10³ CFU/ml) in 1 minute of contact time and further small decreases after 5 minutes. Total bacterial kill was not achieved in 5 minutes of contact.

The control samples (S2 and S4) produced significant but smaller decreases in the bacterial count (from 1.5×10³ CFU/ml) in 1 minute and 5 minutes of contact time. This may be partially due to the difficulty of recovering the culture from the panels using swabbing techniques and to the drying out of the culture during the continuous spreading action on the panels.

### Conclusions

The PVC 94 laminated panels treated with 2% anti-microbial composition are effective in reducing the level of MRSA bacteria when in contact in an aqueous medium for short periods.

These coatings would be likely to be very effective in assisting in the control of MRSA bacterial contamination in hospitals and similar environment.

### EXAMPLE 7

Determination of the Anti-Microbial Effect of Coated Test Panels Containing the Anti-Microbial Composition According to Example 1

The microorganisms tested were:

| | | |
|---|---|---|
| Bacillus subtilis | NCTC 44878 | 3.2 × 10⁶ CFU/ml |
| Pseudomonas aeruginosa | NCTC 10662 | 3.6 × 10⁶ CFU/ml |

### Method

Test panels were coated with paint/powder coatings containing the anti-microbial composition according to Example 1. The coated test panels were challenged with broth cultures of the two organisms at the above concentrations for 10 minutes contact time.

The bacterial suspension was pipetted onto the coated test panel and removed with a swab after 10 minutes. The swab was transferred to maximum recovery diluent and plated onto Standard Plate Count Agar, incubated at 30° C. for 24 hours and the total number of colonies counted.

### Results

TABLE 6
Paint Coating

| | Bacillus subtilis | Pseudomonas |
|---|---|---|
| Panel Number | (CFU/ml) | aeruginosa (CFU/ml) |
| 1 | 20 | 32 |
| 2 | 7 | 3 |
| 3 | TNC | TNC |
| 4 | 60 | 15 |
| 5 | 83 | 41 |
| 6 | TNC | TNC |

TABLE 7
Epoxy Polygloss Powder Coating

| | Bacillus subtilis | Pseudomonas |
|---|---|---|
| Panel Number | (CFU/ml) | aeruginosa (CFU/ml) |
| 1 | TNC | TNC |
| 2 | TNC | 286 |
| 3 | TNC | 132 |
| 4 | 30 | 9 |
| 5 | 150 | 24 |
| 6 | 42 | 30 |

TABLE 8
Grey Epoxy Polyester Gloss Powder Coating

| | Bacillus subtilis | Pseudomonas |
|---|---|---|
| Panel Number | (CFU/ml) | aeruginosa (CFU/ml) |
| 1 | 4 | 13 |
| 2 | 10 | 9 |
| 3 | 6 | 5 |
| 4 | TNC | TNC |
| 5 | TNC | TNC |

### Conclusion

The results show that the bacteria are almost completely eradicated within 10 minutes contact time by the anti-microbial composition according to Example 1 in many of the paint/powder coating formulations, even though the surface is dry.

A powder coating containing the anti-microbial composition according to Example 1 at the concentrations shown to be effective is, therefore, likely to be highly effective in reducing the number of bacteria on a surface in a short timescale.

1. An anti-microbial composition comprising (i) an anti-microbial agent, (ii) a polar solvent and (iii) a surface orienting species, which concentrates the anti-microbial agent at a surface of the composition, whereby substantially to prevent the formation of microbial colonies on or at the said surface.

2. An anti-microbial composition according to claim 1, comprising at least one anti-microbial agent selected from bacteriocidal, fungicidal, algicidal, yeasticidal and moldicidal agents.

3. An anti-microbial composition according to claim 1 and claim 2, wherein the anti-microbial agent is of a polar nature.

4. An anti-microbial composition according to any one of the preceding claims, comprising at least one anti-microbial agent selected from amphoteric compounds, iodophores, phenolic compounds, quaternary ammonium compounds, hypochlorites and nitrogen based heterocyclic compounds.

5. An anti-microbial composition according to claim 4, wherein the or each amphoteric compound is a long-chain N-alkyl derivative of an amino acid.

6. An anti-microbial composition according to claim 5, wherein the amphoteric compound is a long chain N-alkyl derivative of glycine, alanine or beta-amino butyric acid.

7. An anti-microbial composition according to claim 6, wherein the amphoteric compound is dodecyl beta-alanine, dodecyl beta-aminobutyric acid, dodecylamino-di(aminoethylamino)glycine or N-(3-dodecylamino)propylglycine.

8. An anti-microbial composition according to claim 4, wherein the or each iodophore is a complex of iodine or triodine with polyvinylpyrrolidone, a polyether glycol, a polyvinyl alcohol, a polyacrylate, a polyamide, a polyalkylene or a polysaccharide.

9. An anti-microbial composition according to claim 4, wherein the or each quaternary ammonium compound has the general formula R¹R²R³R⁴N⁺X⁻, in which one or two of the R groups are alkyl, optionally substituted by aryl or optionally interrupted by aryl or a heteroatom, and the other R groups are the same or different and are C₁ to C₄ alkyl groups.

10. An anti-microbial composition according to claim 9, wherein the quaternary ammonium compound is a benzalkonium halide, an aryl ring substituted benzalkonium halide or a dialkyldimethyl ammonium compound wherein the two non-methyl alkyl groups are selected from C₈ to C₁₂ alkyl.

11. An anti-microbial composition according to claim 10, wherein the quaternary ammonium compound is benzenethanaminiumn N-dodecyl-N,N-dimethylchloride, benzenethanaminiumn N-dodecyl-N,N-dimethyl-N-tetradecylchloride or benzyl-C₁₂-C₁₆-alkyldimethyl-ammoniumchloride.

12. An anti-microbial composition according to claim 4, wherein the or each phenolic compound is a methyl, ethyl, butyl, halo or aryl substituted phenol.

13. An anti-microbial composition according to claim 12, wherein the phenolic compound is 2-phenylphenol, 2-benzyl-4-chlorophenol, 2-cyclopentanol-4-chlorophenol, 4-t-amylphenol, 4-t-butylphenol, 4-chloro-2-pentylphenol, 6-chloro-2-pentylphenol, p-chloro-meta-xylenol, 2,4,4-trichloro-2-hydroxydiphenol, thymol, 2-i-propyl-3-methylphenol, chlorothymol, 3-methyl-4-chlorophenol, 2,6-dichloro-4-n-alkyl phenols, 2,4-dichloro-meta-xylenol, 2,4,6-trichlorophenol or 2-benzyl-4-chlorophenol.

14. An anti-microbial composition according to claim 4, wherein the or each hypochlorite is a hypochlorite of an alkali metal or an alkaline earth metal.

15. The anti-microbial composition according to claim 14, wherein the hypochlorite is a hypochlorite of lithium, sodium, potassium or calcium.

16. An anti-microbial composition according to claim 15, wherein the hypochlorite is a chlorinated trisodium phosphate or a hydrate thereof.

17. The anti-microbial composition according to claim 15, wherein the hypochlorite is chlorine dioxide or a precursor thereof, N,N-dichloro-4-carboxybenzenesulphonamide, 1,3 -dichloro-5,5-dimethylhydantoin, or a derivative of chloroisocyanuric acid.

18. An anti-microbial composition according to claim 4, wherein the or each nitrogen based heterocyclic compound is a pyridine derivative, a triazole or an imidazole.

19. An anti-microbial composition according to claim 18, wherein the nitrogen based heterocyclic compound is 4-pyridine carboxylic acid hydrazide, sodium 2-pyridinethiol or bis-(2-pyridylthio)zinc-1,1-dioxide.

20. A composition according to any preceding claim, wherein the anti-microbial agent is benzenethanaminiumn N-dodecyl-N,N-dimethylchloride, benzenethanaminiumn N-dodecyl-N-N-dimethyl-N-tetradecylchloride, benzyl-C₁₂-C₁₆-alkyldimethyl-ammoniumchloride, 2-phenyl phenol, 2-octyl-2H-isothiazol-3-one, 5-chloro-2-methyl-2H-isothiazol-3-one and 2-methyl-2H-isothiazol-3-one.

21. An anti-microbial composition according to any preceding claim, wherein the surface orienting species is a C₁₂ to C₂₀ surfactant or oil.

22. An anti-microbial composition according to claim 20, wherein the surface orienting species is polysiloxane, polyethylene glycol, sodium lauryl sulphate or soya lecathin.

23. An anti-microbial composition according to any preceding claim, comprising from 1 to 4% by volume of the surface orienting species.

24. An anti-microbial composition according to any preceding claim, wherein the polar solvent is water, an alcohol, an ester, a hydroxy or glycol ester, a polyols or a ketone.

25. An anti-microbial composition according to claim 24, wherein the polar solvent is isopropanol, diethylene glycol or dipropylene glycol.

26. An anti-microbial composition according to any preceding claim, comprising from 1 to 70% by volume of the polar solvent.

27. An anti-microbial composition according to any preceding claim, wherein the composition comprises 32% by volume of a mixture of benzenethanaminiumn N-dodecyl-N,N-dimethylchloride and benzenethanaminiumn N-dodecyl-N,N-dimethyl-N-tetradecyl-chloride (2.33:1), 6.0% by volume of a mixture of benzyl-C₁₂-C₁₆-alkyldimethyl-ammoniumchloride and 2-phenyl phenol (2:1), 6.0% by volume 2-octyl-2H-isothiazol-3-one, 16.0% by volume of a mixture of 5-chloro-2-methyl-2H-isothiazol-3-one and 2-methyl-2H-isothiazol-3-one (3:1), 1.0% by volume a blend of polysiloxanes and 39% by volume isopropanol.

28. A formulation comprising the anti-microbial composition according to any one of the preceding claims and a functional material.

29. A formulation according to claim 28, wherein the functional compound is selected from plastics, fibres, coatings, films, laminates, adhesives, sealants, clays, china, ceramics, concrete, sand, paints, varnishes, lacquers, cleaning agents or settable or curable compositions such as fillers, grouts, mastics and putties.

30. A formulation according to claim 28 or claim 29, wherein the formulation comprises from 0.1 to 5.0% by weight of the anti-microbial composition.

31. A formulation according to claim 30, wherein the formulation comprises from 0.5 to 2.0% by weight of the anti-microbial composition.

32. The use of an anti-microbial composition according to any one of claims 1 to 27, to prevent the formation of colonies of microorganisms on a surface at which it is provided.

33. The use of a formulation according to any one of claims 28 to 31, to prevent the formation of colonies of microorganisms on a surface at which it is provided.

34. The manufacture of an anti-microbial composition according to any one of claims 1 to 27, comprising the steps of (i) mixing the anti-microbial agents together, (ii) adding the surface orienting species to the mixture of anti-microbial agents, (iii) adding the polar solvent to the mixture of the anti-microbial agents and surface orienting species and (iv) agitating the resulting mixture until a clear solution is formed.

35. The manufacture of a formulation according to any one of claims 28 to 31, comprising the step of adding the anti-microbial composition to the functional compound.

36. A composition generally as herein described.

37. A formulation comprising the anti-microbial composition generally as herein described.
